(19) United States
(12) Patent Application Publication
(10) Pub. No.: US 2026/0063333 A1
(43) Pub. Date: Mar. 5, 2026

(54) SYSTEMS AND METHODS FOR AUTOMATIC SOLAR TABLE LANDING AND SECUREMENT

(71) Applicant: Terabase Energy, Inc., Berkeley, CA (US)

(72) Inventors: Soren Jensen, Corte Madera, CA (US); Tyler Grushkowitz, Corvallis, OR (US); Adam Hansel, Davis, CA (US); Matthew Paul Campbell, Berkeley, CA (US)

(73) Assignee: Terabase Energy, Inc., Berkeley, CA (US)

(21) Appl. No.: 18/991,103

(22) Filed: Dec. 20, 2024

Related U.S. Application Data
(60) Provisional application No. 63/690,797, filed on Sep. 4, 2024.

(51) Int. Cl. F24S 25/00

(52) U.S. Cl. CPC F24S 25/00; F24S 2025/014

(57) ABSTRACT

In solar systems, the installation process for solar table is typically implemented manually by an installer. Such a manual process negatively impacts cost-effectiveness and installation consistency, especially for large solar systems. The present invention discloses system and method embodiments of automatic solar table landing and securement by a solar table mobile transport or a lander vehicle. The solar table mobile transport or the lander vehicle may be controlled to allow motorized and automatic alignment of the solar table while it is still secured to the mobile transport or the lander. As a result, installation efficiency may be significantly improved.

### CROSS-REFERENCE TO RELATED APPLICATION

This application claims the priority benefit under 35 U.S.C. § 119(e) to U.S. Provisional Ser. No. 63/690,797, filed on Sep. 4, 2024, entitled “SYSTEMS AND METHODS FOR AUTOMATIC SOLAR TABLE LANDING AND SECUREMENT” and listing Soren Jensen as inventor. The aforementioned patent document is incorporated by reference herein in its entirety.

### TECHNICAL FIELD

The present disclosure relates generally to centralized assembly and installation of solar systems. More particularly, the present disclosure relates to systems and methods for automatic solar table landing and securement for improved transportation and installation efficiency.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the cost-effective management of the construction process and the ability to move components around the site efficiently during the construction process.

Large-scale solar panel systems typically include thousands of solar panels that are located across a multi-acre terrain and that are electrically coupled to provide a source of energy. These large-scale systems are often located in remote areas and require a significant investment in materials, resources, and labor for installation and design. The sourcing and delivery of materials and resources for these installations can be problematic and inconsistent. A further complication is the reliable and safe movement of these materials and resources across large areas of the construction site as well as maintaining consistent installation processes at each point of installation within the site. These issues further contribute to an increase in the cost and complexity of a very cost-sensitive process.

FIG. 1 illustrates a typical prior-art installation process for solar systems. This prior-art installation process is implemented such that all mounting equipment for each solar panel is individually assembled and installed at its location within a large system. The cost-effectiveness of this approach works fine within smaller solar deployments but struggles to cost-effectively scale to large solar systems as described below.

This traditional deployment 101 relies on materials delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is repeated for an adjacent location 103 where materials are subsequently delivered, assembled, and installed for a neighboring solar table within the system. While this approach may be effectively deployed in the installation of smaller solar systems, it becomes ineffective and cost-prohibitive as the size of the system increases.

What is needed are systems, devices, and methods that improve installation efficiency for large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 shows a prior art assembly and installation process of large-scale solar panel systems.

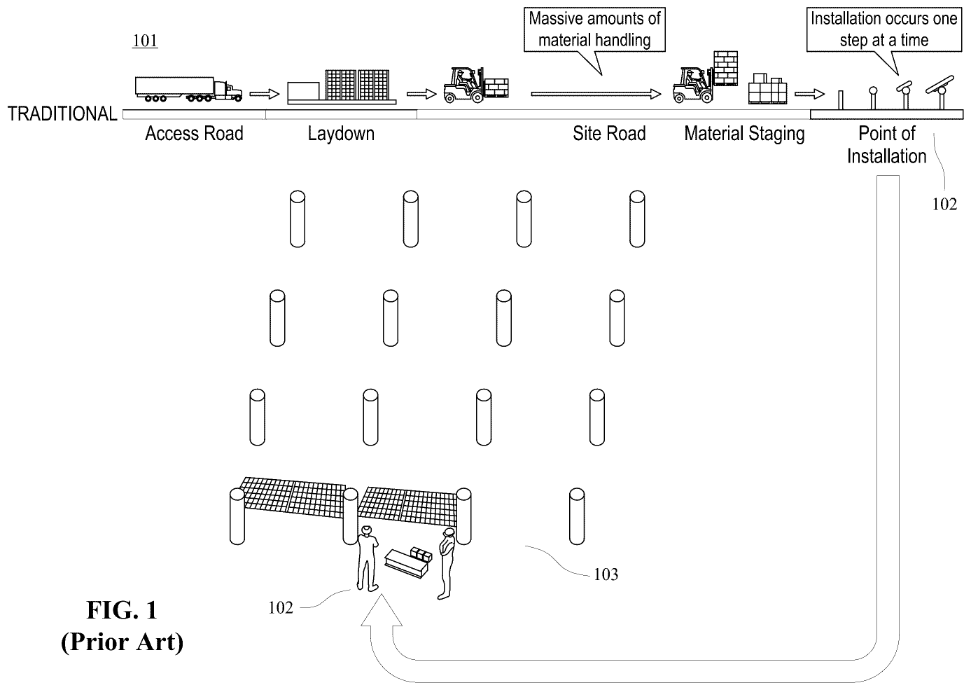

FIG. 2 is a diagram showing a centralized assembly and installation of a solar system including mobile transport of solar tables in accordance with various embodiments of the invention.

FIG. 3 is an exemplary sequence of diagrams illustrating an installation of a solar table within a solar system using a mobile transport according to various embodiments of the invention.

FIG. 4A is a perspective view of a solar table on a mobile transport according to various embodiments of the present invention.

FIG. 4B is a perspective view of a mobile transport unloading a solar table to a lander according to various embodiments of the present invention.

FIG. 5 is a close-up view of two ends of a torque tube according to various embodiments of the present invention.

FIG. 6 is a system view for automatic solar table landing and securement according to various embodiments of the present invention.

FIG. 7 is a perspective view of a torque tube aligned to a torque tube of a previously installed solar table and secured to a pile according to various embodiments of the invention.

FIG. 8 is a process diagram for automatic solar table landing and securement for torque tubes having swaged and unswaged ends according to various embodiments of the invention.

FIG. 9A is a schematic view of two torque tubes connected via a tube coupler according to various embodiments of the invention.

FIG. 9B is a schematic view of two polygon torque tubes connected via a polygon tube coupler according to various embodiments of the invention.

FIG. 10 is an alternative process diagram for automatic solar table landing and securement according to various embodiments of the invention.

FIG. 11 is another alternative process diagram for automatic solar table landing and securement according to various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport.

Furthermore, connectivity between components or systems within the figures is not intended to be limited to direct connections. Also, components may be integrated together or be discrete prior to the construction of a solar panel mobile transport.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functions may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict. Additionally, embodiments of a solar table rack may be used in smaller solar farm construction sites.

In this document, “large-scale solar system” refers to a solar system having 1,000 or more solar panels. The word “resources” refers to material, parts, components, equipment or any other items used to construct a solar table and/or solar system. The word “personnel” refers to any laborer, worker, designer, or individual employed to construct or install a solar table or solar system. The term “solar table” refers to a structural assembly comprising a torque tube and/or purlins with module rails. Some types of solar tables may have supplemental structure that allows them to connect to foundations/piles, while other types do not have this supplemental structure. A solar table may have (but is not required) one or more solar panels and/or electrical harnesses. The term “solar table mobile transport” (hereinafter, “mobile transport”) describes a vehicle used to move a solar table to an installation site and facilitate the installation process of the solar table. A mobile transport may be driven by personnel, controlled by remote control or move autonomously within at least a portion of a solar system construction site. The term “transport component” refers to a lower portion of the mobile transport that provides movement and includes wheels (or similar features such as tracks, a tractor assembly or robotic system), steering mechanism (autonomous or personnel driven) and braking mechanism.

In this document, the “motor” is defined as a structural device that produces motion, unidirectional or multidirectional, of a solar table. Examples of some motors may include elements such as actuators, tracks, etc. that help in producing motion of structures within the mobile transport or the solar table.

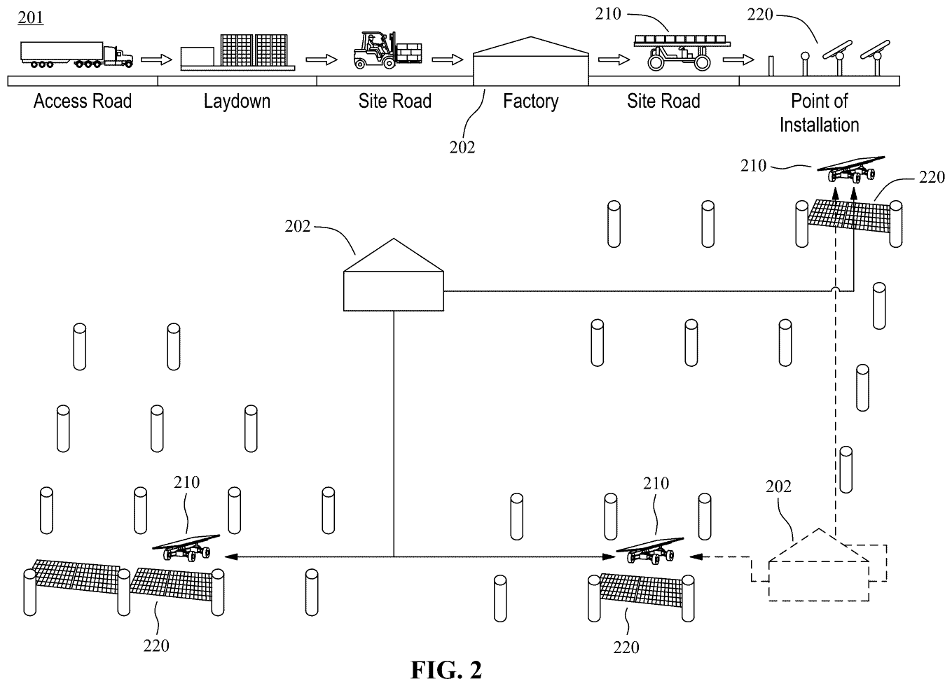

FIG. 2 provides an overview of a centralized solar table assembly and installation for large-scale solar systems according to various embodiments of the invention. Embodiments of the invention transition the traditional approach of distributed assembly and installation at single location sites to a centralized and coordinated assembly factory that allows a more cost-effective and dynamic process of constructing large-scale solar systems. This centralized assembly of solar system components, such as solar tables, necessitates a more robust transport vehicle to move the preassembled components to the installation site.

Resources are brought to construction site 201 for a large-scale solar system and initially processed. These resources are delivered to one or more assembly factories 202 where a coordinated and centralized solar table assembly process is performed. In certain embodiments, a construction site may have multiple centralized factories 202. The location and number of centralized factories 202 may depend on several parameters, including the size of the site, the terrain of the site, the design of the site, and other variables that relate to the construction of the large-scale solar system. Solar tables may be preassembled at a centralized factory 202 and to a point of installation 220 via motorized vehicles 210.

Assembled solar tables and equipment are moved from factory 202 to a point of installation 220 via motorized vehicles 210 such as mobile transports with sideshift capability. In certain embodiments, the mobile transports are specifically designed to transport solar tables along a site road to the point of installation 220. As previously mentioned, the mobile transports 210 may be driven by personnel, may be controlled by remote control, or autonomously driven by a computer system. The time and/or sequence in which solar tables are delivered to points of installation 220 may depend on various factors that may be analyzed to configure a preferred schedule.

Delivery of an assembled solar table to an installation site requires an alignment process to secure points at the installation site. Because an assembled solar table is often large and heavy, this alignment process may be difficult and require significant manual effort by personnel to properly align both ends of a solar table to receptors, piles, or other coupling elements at the installation site.

Described hereinafter are systems and methods for automatic solar table landing and securement for improved transportation and installation efficiency. The solar table mobile transport or a specific lander vehicle may be controlled to allow motorized and automatic alignment of the solar table while it is still secured to the mobile transport. As a result, installation efficiency may be significantly improved.

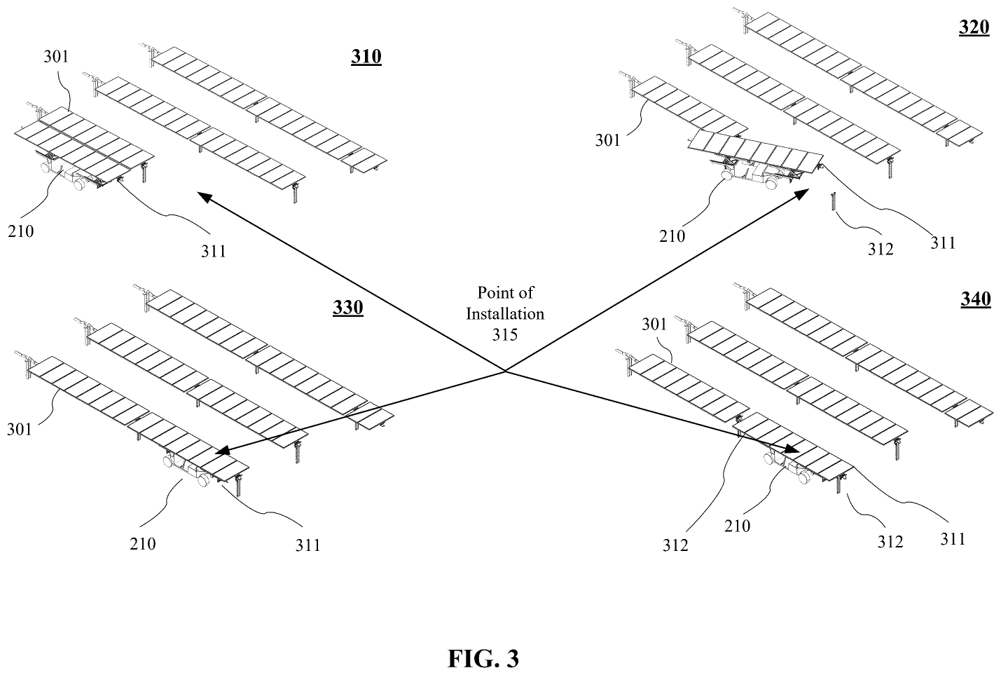

FIG. 3 illustrates a sequence of installation steps for a solar table at an installation site using a solar panel mobile transport with sideshift capability according to various embodiments of the invention. As shown in 310, a mobile transport 210 supporting a solar table 311 approaches a point of installation 315. The solar table 311 is secured to the mobile transport 210 by a solar table attachment component that securely holds the solar table above the mobile transport 210. In certain embodiments, the solar table 311 is assembled and secured to the attachment component at a centralized assembly factory and subsequently driven to the point of installation 315.

As shown in 320, the mobile transport 210 approaches the point of installation 315 in preparation for installation within the solar system. The point of installation 315 comprises structures used to secure the solar table 311 within the system. For example, a solar table 311 may be secured to a previously installed table 301 whereby a torque tube in the solar table 311 is aligned and inserted into a torque tube of the previously installed table 301. The solar table 311 may need to be secured to a pile 312 where threaded fasteners/rivets connect its bearing housing assembly/brackets to the pile 312.

As shown in 330, the mobile transport 210 aligns the solar table 311 at the point of installation 315 for subsequent integration into the solar system. This alignment process may be an automatic process and will be discussed in more detail below.

As shown in 340, the solar table is secured within the solar system after alignment is completed. This securement process may also be an automatic process and include attaching the solar table 311 to the pile 312 that locks the solar table in line with the previously installed table 301. Afterward, the mobile transport 210 detaches from the solar table 311 and may leave the point of installation 315 to go back to the centralized factory 202.

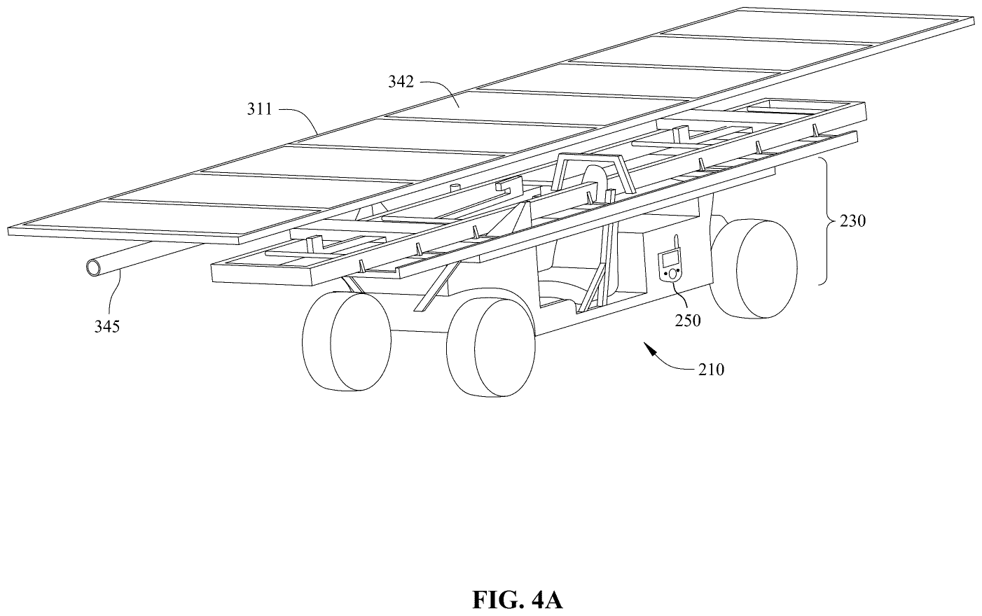

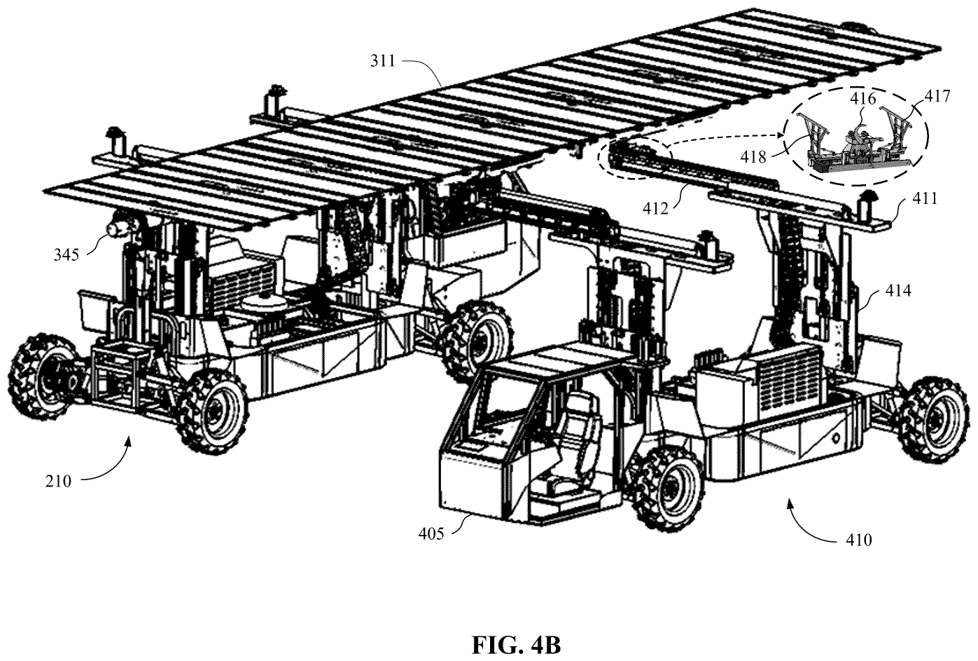

FIG. 4A is a perspective view of a solar table 311 on a mobile transport 210 according to various embodiments of the present invention. The solar table 311 comprises one or more solar modules 342 securely attached to a torque tube 345. This mobile transport 210 comprises a transport component 230 that can securely move the solar table 311 to an installation point. The mobile transport 210 may comprise components to allow a dynamic alignment process for a torque tube 345 of the solar table 311 at the installation site. This mobile transport 210 may further comprise a Global Positioning System (GPS) receiver 250 to record a GPS coordinate of the mobile transport 210 at various locations, such as an installation location where the mobile transport 210 arrives to unload the solar table 311 for installation.

The transport component 230 comprises a vehicular segment that can move throughout a solar system construction site under the control of a driving system. Examples of the vehicular segment include a wheel system, tractor system and/or robotic movement system to move a solar table from a factory to an installation point. The transport component 230 comprises a driving system that effectively controls the movement of the mobile transport as it carries a solar table from a centralized factory to an installation site. The driving system may comprise various sensors, e.g., camera(s), lidar sensor(s), and/or ultrasonic distance sensor(s) to allow autonomous driving.

In one or more embodiments, the mobile transport 210 may handle both transporting and installing of the solar table 311. Alternatively, the mobile transport 210 may only deliver autonomously the solar table on-site without articulation or side-shift capability for solar table landing. Instead, a dedicated lander vehicle, also referred to as a lander, picks the solar table 311 from the mobile transport 210 directly or from where the mobile transport 210 drops the the solar table 311 for installation. The lander has appropriate articulation and side-shift capabilities. Therefore, the automatic solar table landing and installation may be performed by the mobile transport, a lander, or a combination of both.

FIG. 4B is a perspective view of a mobile transport unloading a solar table to a lander according to various embodiments of the present invention. The lander 410, which picks up solar table 311 from the mobile transport 210 directly or from where the mobile transport 210 drops the the solar table 311 for installation. The lander 410 comprises a base vehicle 405 to provide movement, a pair of support rails 411, a pair of sliding rails 412 slidably attached to respective support rails, a pair of vertical motion elements 414 attached to the base vehicle to enable vertical motion of support rails 411. A tube hook 416 may be deployed on each sliding rail 412 to hold the torque tube 345 of the solar table 311 securely during the fetching or installation process. A pair of anti-rotational wings 417/418 may be placed on both sides of the tube hook 416 to provide stable and secure support for the corresponding solar table during the fetching or installation process. After the lander 410 takes possession of the solar table 311, the mobile transport 210 returns to the factory to pick up a new solar table. After the lander 410 completes the installation of the solar table 311, the lander 410 moves to a new point of installation associated with the next solar table. It shall be noted that the mobile transport 210 and the lander may be identical as shown in FIG. 4B, or they may be different with the mobile transport having no or limited articulation of the table support.

In another embodiment, the lander 410 may pick up a solar table directly at the factory and transport it to the point of installation and complete the installation before returning to the factory to pick up the next table. In this embodiment, the lander 410 may perform both tasks of solar table transporting from the factory and solar table installing on-site.

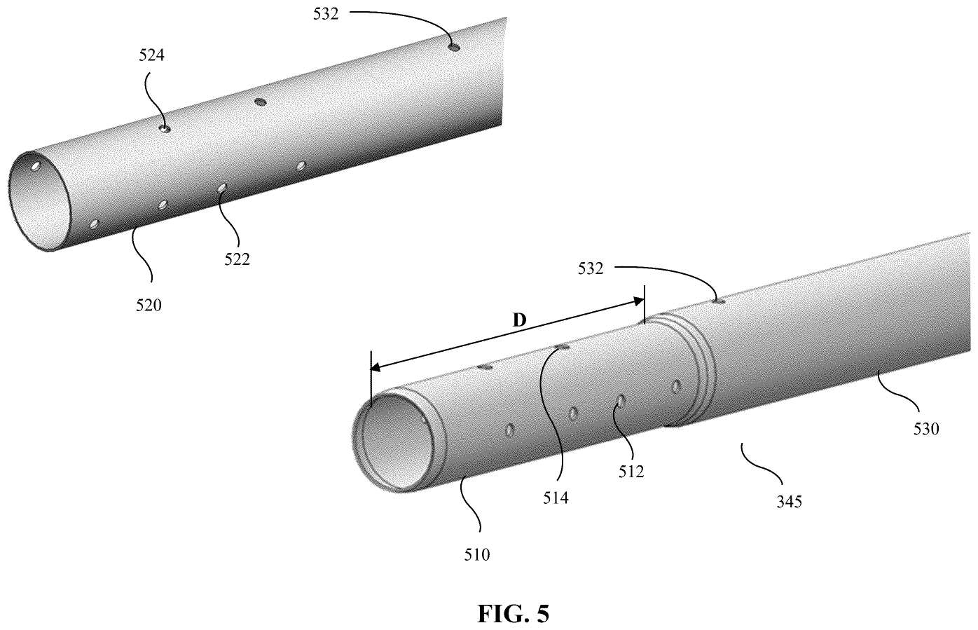

FIG. 5 is a close-up view of two ends of a torque tube according to various embodiments of the present invention. The torque tube 345 comprises a first tube end 510 for tube installation on supporting piles, a second end 520 (shown side-by-side of the first tube end 510 for a close-up view), and a tube body 530 that comprises multiple bracket holes 532 that are typically aligned and uniformly spaced for bracket installation. Each bracket hole 532 is used to attach a bracket that engages a module frame of a solar module.

The first tube end 510 is also referred to as a swaged end with a diameter smaller than the diameter of the tube body 530. The second end 520, which is the opposite end of the swaged end, has the same diameter as the diameter of the tube body 520 and is referred as an unswaged end. The torque tube may have a known distance D for the length of the swaged end. Such a known distance D may be used to align two torque tubes. The first tube end 510 has multiple end holes 512 with a pattern matching end holes 522 on the second tube end 520. Such a matching pattern requires a perfect alignment and connection between two torque tubes.

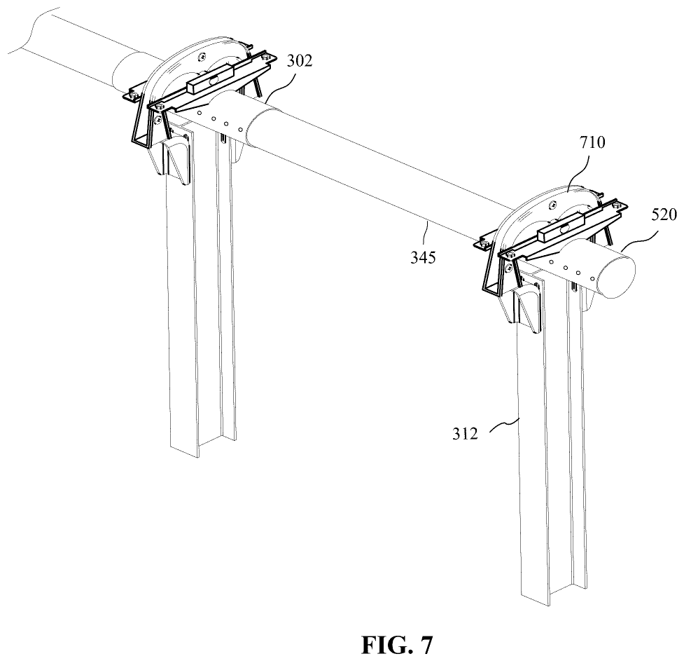

In one or more embodiments, the torque tube 345 further comprises multiple alignment holes 514/524 disposed on the first tube end 510 and the second tube end 520. The alignment holes are for bearing housing assembly (BHA) (e.g., the BHA 710 shown in FIG. 7) installation such that the torque tube 345 may be rotatably secured onto a supporting pile. The alignment holes on the first tube end and the second tube end may have a matching pattern, e.g., inter-hole distance and hole-edge distance, for coupling alignment between two torque tubes. For example, a torque tube may have its swaged end inserted into an unswaged end of a previously installed torque tube with the alignment holes of both tubes aligned for jointly secured by a BHA onto a support pile.

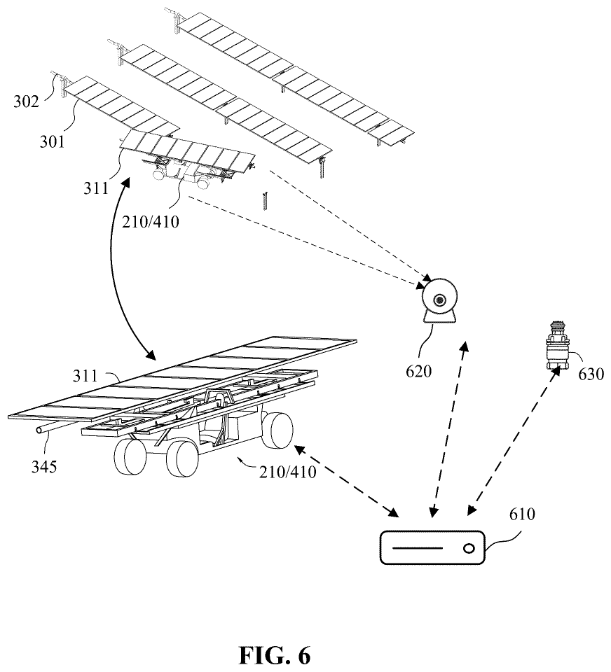

FIG. 6 is a system view for automatic solar table landing and securement according to various embodiments of the present invention. The system comprises the mobile transport 210 (or a lander), one or more cameras 620 (or lidar sensors), one or more proximity sensors 630 (e.g., ultrasonic proximity detectors), and a controller 610 coupled to the mobile transport 210 (or the lander 410), the one or more cameras 620, and the one or more proximity sensors 630. The controller 610, the one or more cameras 620, and the one or more proximity sensors 630 may all be integrated into the mobile transport 210 (or the lander 410). Additionally, the mobile transport 210 may comprise one or more load sensors which may be used to monitor whether the solar table 311 is unloaded from the mobile transport.

When the mobile transport 210 (or the lander 410) arrives at the point of installation 315, the one or more cameras 620 capture ambient images around the point of installation 315 for the controller 610 to identify and locate a previously installed solar table 301 for table alignment and a pile 312 for table landing. The information to be gathered for the torque tube 302 of the previously installed solar table 301 includes x, y, and z coordinates of the intersection of a vector going through a set of rivet/bolt holes and a vector going through the centerline of the tube 302. Similar information is also needed for the swaged section as well. An optical or mechanical method to ensure final alignment of the bolt/rivet hole patterns may also be implemented as an option.

The controller 610 controls the mobile transport 210 (or the lander 410) to automatically maneuver into a desired parking position for table landing, with the help of the cameras 620 and the proximity sensors 630. The mobile transport 210 (or the lander 410) then aligns the solar table 311 to the previously installed solar table 301 and the pile 312. The mobile transport 210 (or the lander 410) may raise, lower, tilt, roll, rotate, and/or sideshift the solar table 311 into an aligned position.

The aligning and landing of the solar table is monitored using feedback from one or more load sensors deployed on the mobile transport and ongoing images captured from one or more cameras or lidar sensors deployed on the mobile transport. The whole installation process may be improved through machine learning and AI to manage the multitude of combinations of variables and conditions that may require corrective action.

FIG. 7 is a perspective view of a torque tube aligned to a torque tube of a previously installed solar table and secured to a pile according to various embodiments of the invention. Solar modules are not shown in FIG. 7 for the purpose of a transparent perspective view of the torque tubes. The torque tube 345 of the solar table 311 is engaged to the torque tube 302 of the previously installed solar table 301 (for figure clarity, only torque tube 302 shown in FIG. 7) with the swaged end of the torque tube 345 inserted into the unswaged end of the torque tube 302, and holes overlaid for securing. Furthermore, the torque tube 345 is landed and supported by the pile 312 with a bearing housing 710 aligned and placed on the pile 312 to secure the torque tube 345.

It shall be noted that the solar table 311 may be installed at a point of installation without a previously installed solar table to align. For example, the solar table 311 may be the first to be installed in a row. In this circumstance, the mobile transport 210 needs to align/land the solar table 311 with two supporting piles for securement. For example, the torque tube of the solar table 311 may have one end inserted in a slew drive tube and a back end landed on the next pile. Subsequent solar tables may have their torque tubes installed similarly.

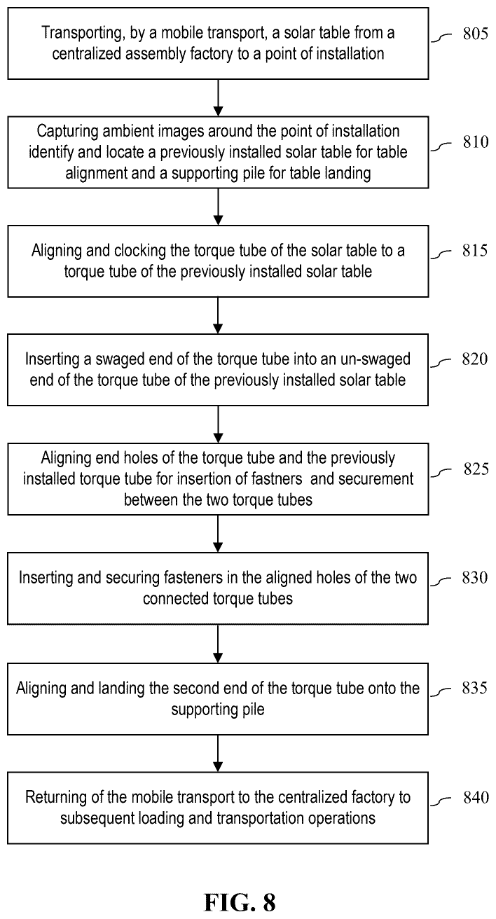

FIG. 8 is a process diagram for automatic solar table landing and securement according to various embodiments of the invention. In step 805, a solar table is loaded onto a mobile transport for transportation from a centralized assembly factory to the point of installation. The point of installation may be associated with a pile or a pair of piles to support the solar table, with each pile having predetermined geographic information, such as a GPS coordinate or local geographical information (e.g., a row number and a column number for the pile among all piles within the solar farm). In one or more embodiments, the predetermined geographic information may be available in a solar system infrastructure database, e.g., a local or a cloud database, and accessible by authorized personnel. The point of installation may also be determined automatically by an algorithm in a Material Execution System (MES).

In step 810, ambient images, e.g., camera images or lidar images, around the point of installation are captured to identify and locate a previously installed solar table for table alignment and a supporting pile for table landing, or to locate a pair of supporting piles for table landing if there is no previously installed solar table for alignment.

In step 815, the torque tube of the solar table is aligned and clocked to a torque tube of the previously installed solar table (also referred to as a previously installed torque tube). This step may involve automatic maneuver of the mobile transport into a parking position for alignment of the torque tube and insertion of the first end (swaged end) of the torque tube into the unswaged end of the torque tube of the previously installed solar table.

In step 820, a swaged end of the torque tube of the solar table to be installed in inserted into an unswaged end of the torque tube of the previously installed solar table.

In step 825, end holes of the torque tube and the previously installed torque tube are aligned for insertion of fasteners and securement between the two torque tubes. The fasteners may be pull rivets or threaded fasteners. In one or more embodiments, mechanical verification may be performed after the alignment and clocking of the torque tube of the solar table.

In step 830, fasteners are inserted into the aligned holes and secured to connect the two torque tubes together.

In step 835, the second end (unswaged end) of the torque tube is aligned and landed onto the supporting pile with a bearing housing placed on the supporting pile to secure the torque tube, thus the solar table.

In step 840, the mobile transport unloads the solar table and returns to the centralized factory for subsequent loading and transportation operations. The unloading of the solar table from the mobile transport may be monitored via one or more load sensors (e.g., pressure sensors) deployed on the mobile transport.

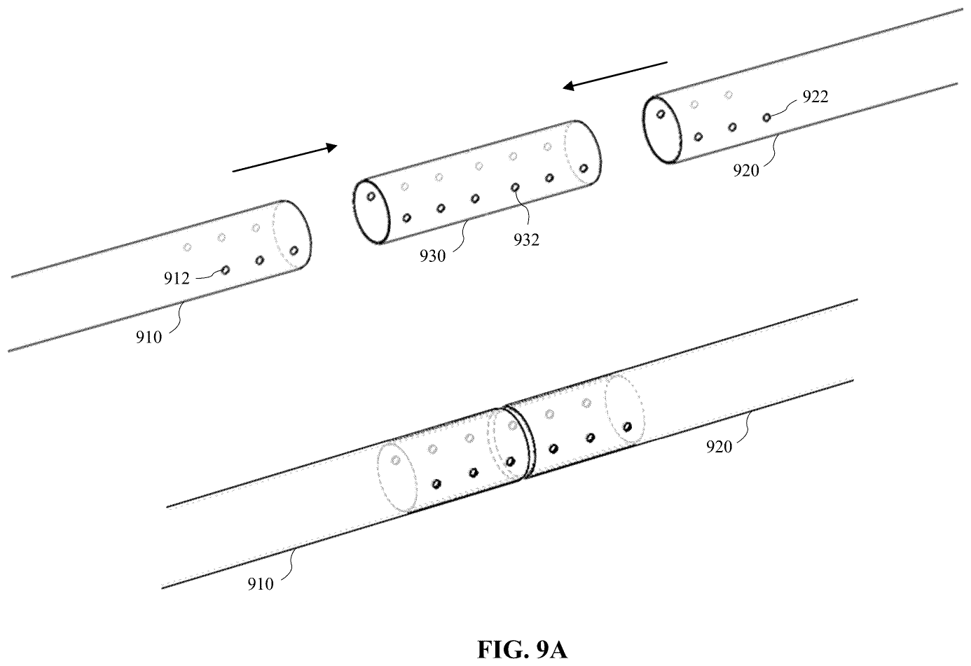

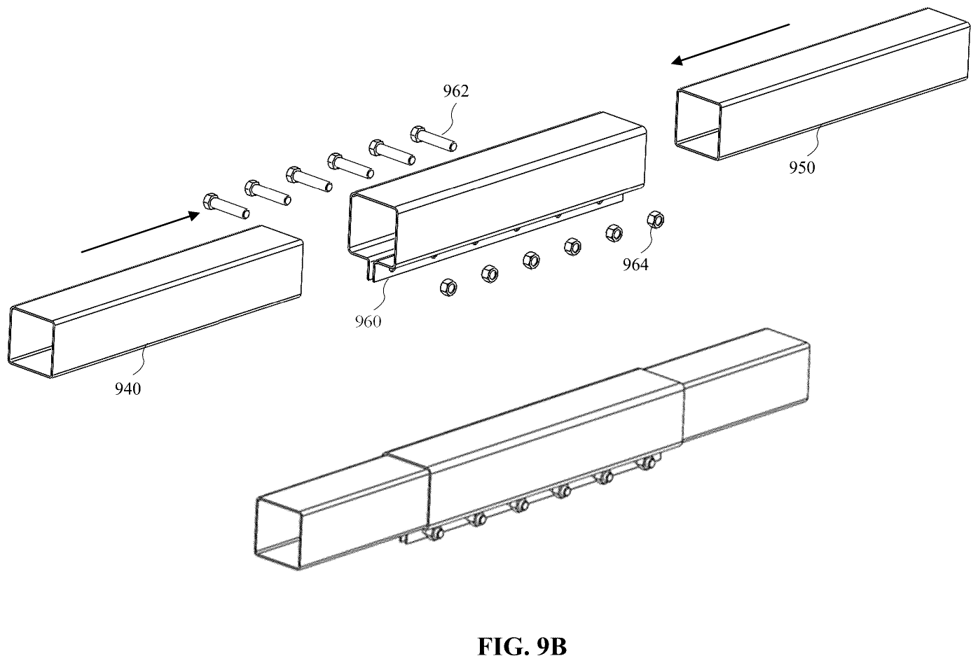

In one or more embodiments, certain torque tubes may not have a swaged end and unswaged end. To implement connections between those torque tubes, a tube coupler is needed. FIG. 9A is a schematic view of two torque tubes 910 and 920 connected via a tube coupler 930 according to various embodiments of the invention. The first torque tube 910 has a first end comprising multiple end alignment holes 912. Similarly, the second torque tube 920 has a second end comprising multiple end alignment holes 924. The tube coupler 930 may be a linear insert that is inserted into the torque tubes 910 and 920. The liner insert comprises a plurality of coupling alignment holes 932 to match the end alignment holes 912/922 such that the torque tubes 910 and 920 can be securely connected via the linear insert. Connection between the torque tube and a supporting pile may be realized through a Bearing Housing Assembly (BHA) that allows rotation of the torque tube but no lateral or horizontal movement, except some in the North-south direction.

Alternatively, the tube coupler 930 may be a sleeve to connect the torque tubes 910 and 920. The sleeve may be a one-piece component, or comprise multiple pieces jointed together to function as a coupler. For example, the sleeve may comprise an upper cover and a lower cover to be bolted or threaded together as a sleeve. Such variations shall be within the scope of the present disclosure.

FIG. 9B is a schematic view of two polygon torque tubes 940 and 950 connected via a polygon tube coupler 960 according to various embodiments of the invention. The polygon tube coupler 960 couples one end of the first polygon torque tube 930 to a corresponding end of the second polygon torque tube 940, and securely holds both tubes together via a plurality of bolts 962 and nuts 964, which are tightened after both tubes are in desired positions. In this configuration, alignment holes on the tubes/coupler may not be needed for secure tube coupling.

Although the coupler 960 showing in FIG. 9B has a one-piece sleeve configuration, one skilled in the art shall understand that various other configurations, e.g., a two-piece design, may also be applicable for coupling the torque tubes together. The polygon tube coupler may have a cross-sectional profile of a square, a rectangle, a hexagon, an octagon, etc., to couple various polygon torque tubes.

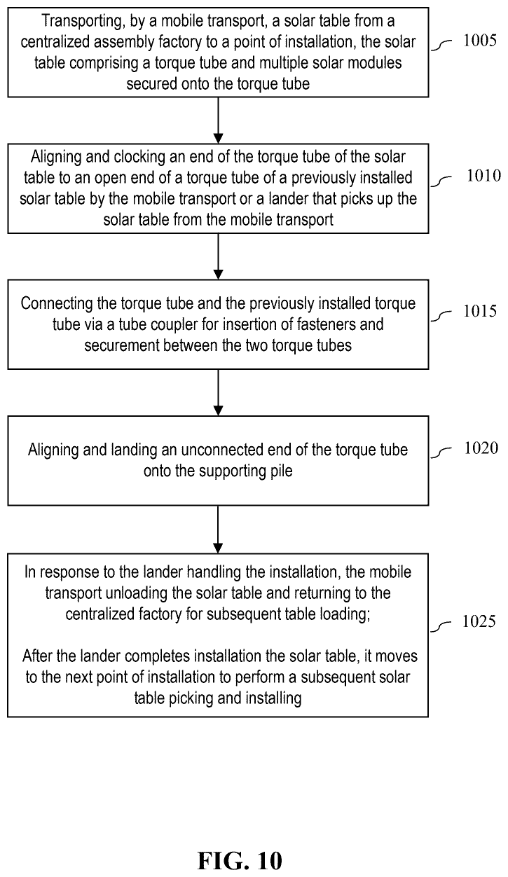

FIG. 10 is an alternative process diagram for automatic solar table landing and securement according to various embodiments of the invention. In step 1005, a solar table is loaded onto a mobile transport for transportation from a centralized assembly factory to a point of installation. The solar table comprises a torque tube and multiple solar modules secured onto the torque tube. Depending on the type of the torque tube, a tube coupler may be pre-installed onto the torque tube. Alternatively, the tube coupler may be installed onto a torque tube after the solar table is landed onto supporting pile(s) or be installed when two torque tubes are coupling together. The mobile transport may perform solar table installation once it arrives at the point of installation or drop the solar table to a lander and return it to the centralized assembly factory to load another solar table.

In step 1010, an end of the torque tube of the solar table is aligned and clocked to an open end of a torque tube of the previously installed solar table by the mobile transport or a lander that picks up the solar table from the mobile transport. This step may involve automatic maneuver of the mobile transport or the lander into a parking position for alignment of the torque tube to the open end of the torque tube of the previously installed solar table. The previously installed solar table may be identified and located based on ambient images, e.g., camera images or lidar images, around the point of installation captured by the mobile transport or the lander.

In step 1015, the torque tube and the previously installed torque tube are aligned and connected via the tube coupler for insertion of fasteners and securement between the two torque tubes. The fasteners may be pull rivets or threaded fasteners. The tube coupler may be pre-installed on the solar table at the assembled factory, on an open end of the torque tube of the previously installed solar table right after the previously installed solar table was landed and installed and before the solar table was delivered at the point of installation. Alternatively, tube coupler may be installed in real time when the torque tube and the previously installed torque tube are aligned.

In step 1020, an unconnected end of the torque tube is aligned and landed onto the supporting pile with a bearing housing placed on the supporting pile to secure the torque tube, thus the solar table.

In step 1025, in response to the lander handling the installation, the mobile transport unloads the solar table and returns to the centralized factory for subsequent loading and transportation operations; after completing the table installation, the lander moves to the next point of installation to perform a subsequent solar table picking and installing.

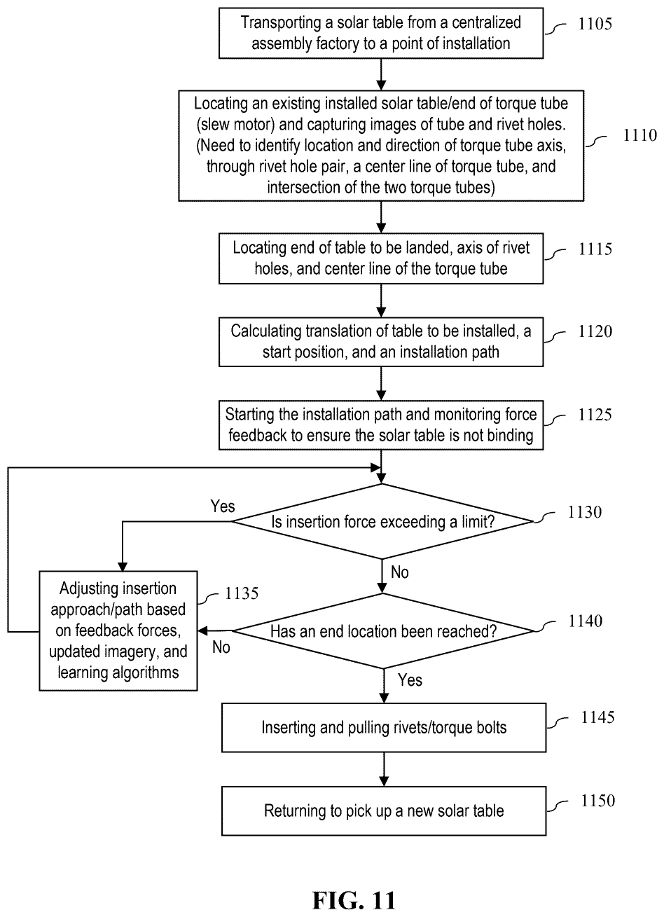

FIG. 11 is another alternative process diagram for automatic solar table landing and securement according to various embodiments of the invention. In step 1105, a solar table is loaded onto a mobile transport for transportation from a centralized assembly factory to a point of installation. The solar table comprises a torque tube and multiple solar modules secured onto the torque tube. In step 1110, an installed solar table or an end of torque tube (slew motor) are located with images of the torque tube and rivet holes captured by one or more cameras or lidar sensors deployed on the mobile transport. In one or more embodiments, this step also involves identifying the location and direction of a torque tube axis of the installed solar table through rivet hole pair, a center line of the torque tube, and an intersection of two torque tubes.

In step 1115, the end of the solar table to be landed, the axis of rivet holes, and the center line of the torque tube are located. In step 1120, a translation of the solar table to be installed, a start position, and an installation path are calculated. In step 1125, the installation path is started with force feedback monitoring to ensure the solar table is not binding. The monitored force may be referred to as an insertion force that is applied to the torque tube of the solar table to be installed to initiate an insertion motion of the torque tube into a coupler or a corresponding end of an installed torque tube.

In step 1130, the insertion force is compared to a limit for insertion force verification. In step 1135, in response to the insertion force exceeding the limit, the insertion path is adjusted based on feedback from the insertion force, updated imagery, and learning algorithms. Afterward, the process goes back to step 1130 for insertion force verification again.

In step 1140, in response to the insertion force not exceeding the limit, a verification is made regarding whether an end location has been reached. The end location is the designated position of the torque tube of the solar table to be installed at the end of the insertion motion. In response to the end location not being reached, the process returns to step 1135 for recalculating the insertion path.

In step 1145, responsive to the end location being reached, rivets or torque bolts are installed to securely lock the torque tube of the solar table to be installed at the end location. In step 1150, the mobile transport returns to the centralized factory to pick up a new solar table to repeat the automatic solar table landing and securement process until all solar tables are installed.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

1. A method of automatic solar table landing and securement, the method comprising:
transporting, by a mobile transport, a solar table from a centralized factory to a point of installation, the solar table comprising a torque tube and multiple solar modules secured onto the torque tube;
capturing ambient images around the point of installation to identify and locate a previously installed solar table for table alignment and a supporting pile for table landing;
aligning and clocking, by the mobile transport or a lander that picks up the solar table from the mobile transport, an end of the torque tube of the solar table to an open end of a torque tube of the previously installed solar table;
connecting the end of the torque tube of the solar table and the open end of the torque tube of the previously installed solar table for insertion of fasteners and securement between the two torque tubes;
aligning and landing an unconnected end of the torque tube of the solar table onto the supporting pile.

2. The method of claim 1, wherein the end of the torque tube of the solar table is a swaged end and the open end of the torque tube of the previously installed solar table is an unswaged end.

3. The method of claim 2, wherein the end of the torque tube of the solar table and the open end of the torque tube of the previously installed solar table are connected via insertion of the swaged end into the unswaged end.

4. The method of claim 1, wherein the end of the torque tube of the solar table and the open end of the torque tube of the previously installed solar table are connected via a tube coupler.

5. The method of claim 4, wherein the tube coupler is a sleeve or a liner insert, the tube coupler is a one-piece component or comprises multiple pieces.

6. The method of claim 4, wherein the tube coupler is pre-installed onto the torque tube at the centralized factory or is installed on the open end of the torque tube of the previously installed solar table after the previously installed solar table was landed and installed.

7. The method of claim 4, wherein the tube coupler is installed in real-time when the end of the torque tube of the solar table and the open end of the torque tube of the previously installed solar table are connected.

8. The method of claim 1, further comprising:
in response to the lander handling the installation, the mobile transport unloads the solar table and returns to the centralized factory for subsequent loading and transportation operations; upon completing installation the solar table, the lander moves to a next point of installation to perform a subsequent solar table picking and installing.

9. (canceled)

10. The method of claim 1, wherein the aligning and landing of the solar table is monitored using feedback from one or more load sensors deployed on the mobile transport and ongoing images captured from one or more cameras or lidar sensors deployed on the mobile transport.

11. A system for automatic solar table landing and securement, the system comprising:
a mobile transport that transports a solar table from a centralized factory to a point of installation, the solar table comprising a torque tube and multiple solar modules secured onto the torque tube; and
a lander that is configured to perform operations comprising:
picking up the solar table from the mobile transport;
identifying and locating a previously installed solar table and a supporting pile based on ambient images around the point of installation captured by one or more cameras or lidar sensors deployed on the lander;
aligning and clocking an end of the torque tube of the solar table to an open end of a torque tube of the previously installed solar table;
connecting the end of the torque tube of the solar table and the open end of the torque tube of the previously installed solar table for insertion of fasteners and securement between the two torque tubes; and
aligning and landing an unconnected end of the torque tube of the solar table onto the supporting pile.

12. The system of claim 11, wherein the end of the torque tube of the solar table is a swaged end and the open end of the torque tube of the previously installed solar table is an unswaged end.

13. The system of claim 12, wherein the end of the torque tube of the solar table and the torque tube of the previously installed solar table are connected via insertion of the swaged end into the unswaged end.

14. The system of claim 11, wherein the end of the torque tube of the solar table and the torque tube of the previously installed solar table are connected via a tube coupler.

15. The system of claim 14, wherein the tube coupler is a sleeve or a liner insert, the tube coupler is a one-piece component or comprises multiple pieces.

16. The system of claim 14, wherein the tube coupler is pre-installed onto the torque tube at the centralized factory or is installed on the open end of the torque tube of the previously installed solar table after the previously installed solar table was landed and installed.

17. The system of claim 14, wherein the tube coupler is installed in real-time when the end of the torque tube of the solar table and the torque tube of the previously installed solar table are connected.

18. The system of claim 11, wherein the lander is configured to perform operations further comprising:
unloading the solar table and moving a next point of installation for subsequent solar table picking and installing.

19. (canceled)

20. The system of claim 11, wherein the aligning and landing of the solar table is monitored using feedback from one or more load sensors deployed on the mobile transport and ongoing images captured from one or more cameras or lidar sensors deployed on the mobile transport.
